(19) United States
(12) Patent Application Publication
(10) Pub. No.: US 2015/0292439 A1
(43) Pub. Date: Oct. 15, 2015

(54) INJECTOR ELEMENT

(71) Applicant: SNECMA, Paris (FR)

(72) Inventors: Laetitia Taliercio, Vernouillet (FR); Dominique Indersie, Vernon (FR)

(73) Assignee: SNECMA, Paris (FR)

(21) Appl. No.: 14/646,685

(22) PCT Filed: Nov. 20, 2013
(86) PCT No.: PCT/FR2013/052803

§ 371 Date: May 21, 2015

(30) Foreign Application Priority Data
Nov. 22, 2012 (FR) 1261147

(51) Int. Cl. F02K 9/52

(52) U.S. Cl. CPC F02K 9/52

(57) ABSTRACT

The invention relates to the field of injectors, and in particular to an injector element (201) having at least one first helical channel (204) and at least one second helical channel (205), each of said helical channels (204, 205) following a respective helix (204a, 205a) centered on a central axis (X) of the injector element (201). The helix (205a) of the at least one second helical channel (205) is situated inside the helix (204a) of the at least one first helical channel (204).

### BACKGROUND OF THE INVENTION

The present invention relates to the field of injectors, and in particular to elements for injecting a mixture of at least two propellants into a combustion chamber, such as for example a combustion chamber of a rocket engine.

Patent document FR 2 712 030 A1 describes a two-propellant injector for injecting into a rocket engine combustion chamber, which injector has a feed structure in which the two propellants feed a plurality of injector elements arranged parallel to one another in an axisymmetric configuration over the surface of a circular injector plate structure that forms part of the injector. Such an injector plate may also be associated with quite a large number of injector elements, for example as many as one hundred or more, with their individual flow rates being combined in order to deliver the total flow rate for the engine.

In that prior art injector, each injector element has a first channel for injecting the first propellant and a second channel for injecting the second propellant, the second channel being annular and coaxially adjacent around the outside of the first channel.

In the present context, the term “annular channel” is used to mean a channel having a radial cross-section showing an annular flow section, whereas a “tubular” channel is used to mean a channel having an uninterrupted cross-section. Furthermore, the terms “upstream” and “downstream” are defined relative to the flow direction of the propellants.

Thus, since the propellants are injected into the combustion chamber via the coaxial channels of the injector elements of the injector of FR 2 712 030 A1, the turbulence that arises in the boundary layers between said concentric and adjacent flows can serve to ensure uniform mixing of the two propellants by shear in their flow.

Nevertheless, starting from that basic concept, difficulties are encountered in changing the geometrical parameters in order to increase the individual power of each injector element without degrading the quality of the injection and of the combustion. With greater flow rates, the mixing becomes less uniform and the quality of combustion degrades.

One technique that has been proposed for improving the quality of mixing is that of imparting turning motion to at least one of the propellants. For that purpose, in the injector element disclosed for example in European patent application EP 0 344 463 A1, a twisted plate is used to generate such turning motion in one of the propellants. In another solution, disclosed in European patent application EP 1 873 390 A2, the injector element has helical channels for injecting one of the propellants. Nevertheless, it is desired to improve the uniformity of mixing above that provided by those devices of the prior art.

### OBJECT AND SUMMARY OF THE INVENTION

The present invention seeks to propose an injector element for injecting at least two propellants into a combustion chamber, the injection element comprising at least one first helical channel and at least one second helical channel, each of said helical channels having a center line following a respective helix centered on a central axis of the injector element, and making it possible to obtain more uniform mixing of the propellants.

In at least one embodiment, this object is achieved by the fact that the helix of the at least one second channel is situated inside the helix of the at least one first channel. Thus, a point of intersection of the center line of at least one second helical channel with a plane perpendicular to said central axis is closer to the central axis than is a point of intersection of the center line of at least one first helical channel with the same plane. These helical channels following concentric helices encourage better mixing of the propellants.

If the injector element has a plurality of such first helical channels and a plurality of such second helical channels, together they form concentric rings around the central axis.

The helix of each helical channel may be a circular helix, i.e. a helix included in a circle, or alternatively it may be a conical helix. Such conical helices enable converging channels to be obtained, thereby encouraging better mixing of the propellants. Helices other than circular or conical helices could nevertheless also be envisaged, depending on requirements.

Also for the purpose of improving mixing of propellants downstream from the injector element, at least one of said helical channels may present a non-circular section that is twisted around the helix. It is thus possible to obtain twisting of the flow lines in each helical channel twisted in this way, thereby facilitating mixing of the propellants downstream.

In order to increase turbulence downstream from the injector element, and also in order to improve mixing of the propellants downstream from the injector element, the helices of the first and second helical channels may turn in opposite directions. This may be particularly effective if the first helical channel is connected to an inlet for a first propellant and the second helical channel is connected to an inlet for a second propellant, which inlet is separate from the inlet for the first propellant, with the turbulence between the two propellants thus being increased.

Nevertheless, it is also possible to envisage that said first and second helical channels are connected to the same propellant inlet. In particular, although not only in this situation, the injector element may have at least one third channel, that may also be helical, following a helix centered likewise on the central axis of the injector element, but possibly presenting as an alternative some other shape, such as for example an annular shape or a straight tubular shape. This third channel may be arranged outside the helix of the first helical channel, inside the helix of the second helical channel, or between the helices of the first and second helical channels.

At least one of the first and second channels may be formed inside a single-piece part. By means of these provisions, it is possible to optimize the section of the helical channel in order to obtain better mixing with reduced head loss. In addition, the injector element may thus be made more robust. Said single-piece part may in particular be produced by additive fabrication.

In order to facilitate mixing, while separating the flow lines of the second propellant, the injector element may have a plurality of helical channels for injecting the second propellant, each following a respective helix centered on the central axis.

### BRIEF DESCRIPTION OF THE DRAWINGS

The invention can be well understood and its advantages appear better on reading the following detailed description of embodiments given as non-limiting registrations. The description refers to the accompanying drawings, in which:

FIG. 1 is a diagrammatic view of a liquid propellant rocket engine;

FIG. 2A is a cutaway side view of an injector element in a first embodiment;

FIG. 2B is a diagrammatic view of the helical channels of the FIG. 2A injector element;

FIG. 3A is a cutaway side view of an injector element in a second embodiment;

FIG. 3B is a diagrammatic view of the helical channels of the FIG. 3A injector element;

FIG. 4A is a cutaway side view of an injector element in a third embodiment;

FIG. 4B is a cross-section view of the FIG. 4A injector element on line IVB-IVB;

FIG. 5 is a cross-section view of an injector element in a fourth embodiment;

FIG. 6A is a diagrammatic view of three helical channels of an injector element in a fifth embodiment;

FIG. 6B is a cross-section view of the FIG. 6A injector element;

FIG. 7A is a diagrammatic side view of a helical channel in a variant of the invention; and

FIG. 7B is a cross-section view of the FIG. 7A channel on plane VIC.

### DETAILED DESCRIPTION OF THE INVENTION

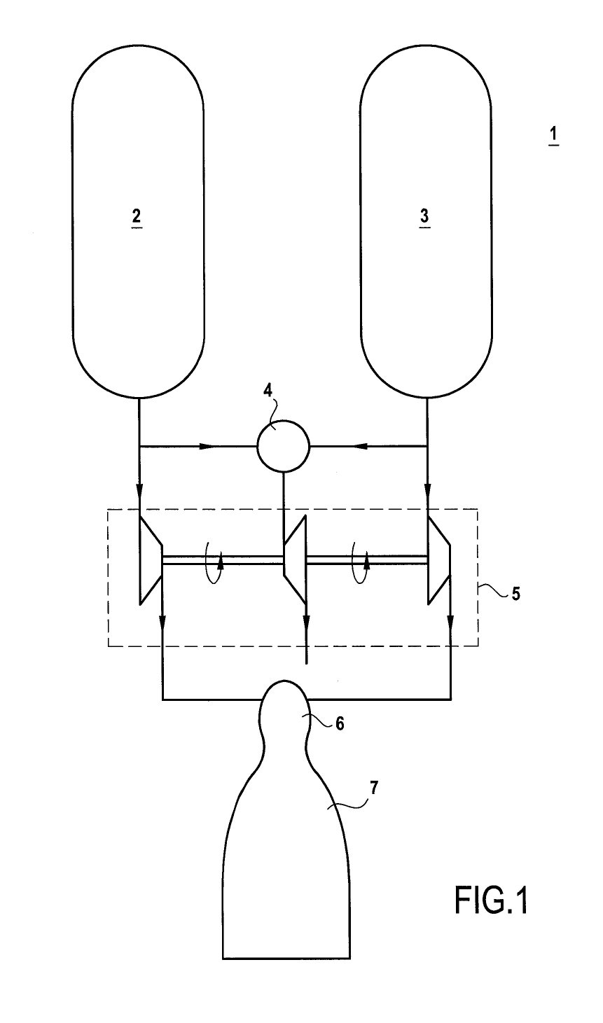

FIG. 1 is a diagram showing a rocket engine 1 having liquid propellants, and in particular cryogenic liquid propellants. The rocket engine 1 has a tank 2 for the first propellant, a tank 3 for the second propellant, a gas generator 4 fed by the first and second propellants, a turbopump 5 actuated by combustion gas coming from the gas generator 4, a main combustion chamber 6 fed with propellants by the turbopump 5, and a converging-diverging nozzle 7 for thrust ejection of the combustion gas generated in the main combustion chamber 6.

In order to obtain efficient combustion both in the gas generator 4 and in the main combustion chamber 6, these components have injector members for injecting propellants that make it possible to obtain a uniform mixture and distribution of the propellants. Typically, these injector members are in the form of injectors comprising an injector plate having a plurality of injector elements for the two propellants arranged therein.

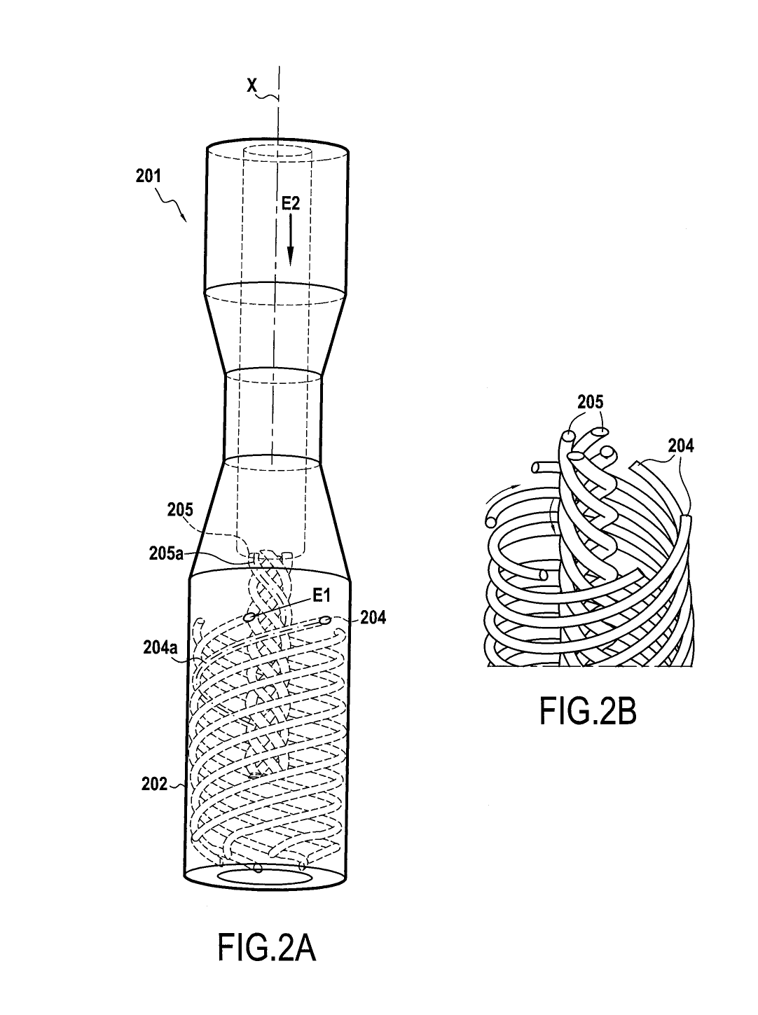

FIGS. 2A and 2B show an injector element 201 for injecting and mixing two propellants E1 and E2. The injector element 201 presents a central axis X, which is also the main flow axis of the propellants E1 and E2.

The injector element 201 comprises a set of first helical channels 204 for injecting the first propellant E1 arranged around a set of second helical channels 205 for injecting the second propellant E2. In this first embodiment, the helices 204a forming the center lines of the first channel 204 are circular helices turning in a first direction and the helices 205a forming the center lines of the second channel 205 are helices that are likewise circular but turning in a second direction opposite to the first direction, about the same central axis X.

The injector element 201 is formed as a one single-piece part with the helical channels 204 and 205 being formed in the mass of this single-piece part.

The first helical channels 204 are connected to an inlet for the first propellant E1 and they are configured to inject this first propellant E1, while the second helical channels 205, situated inside the helices 204a of the first helical channel 204, are connected to an inlet for the second propellant E2 and they are configured to inject this second propellant E2. While the injector element 201 is in operation, the helical channels 204 and 205 separate the flow lines of each of the propellants E1 and E2, imparting rotary motion in opposite directions to each of the propellants. The angle of inclination of the flow of the second propellant E2 relative to that of the first propellant E1 leads to shear between them, producing turbulence that serves to obtain uniform mixing of the two propellants E1 and E2 downstream from the injector element 201.

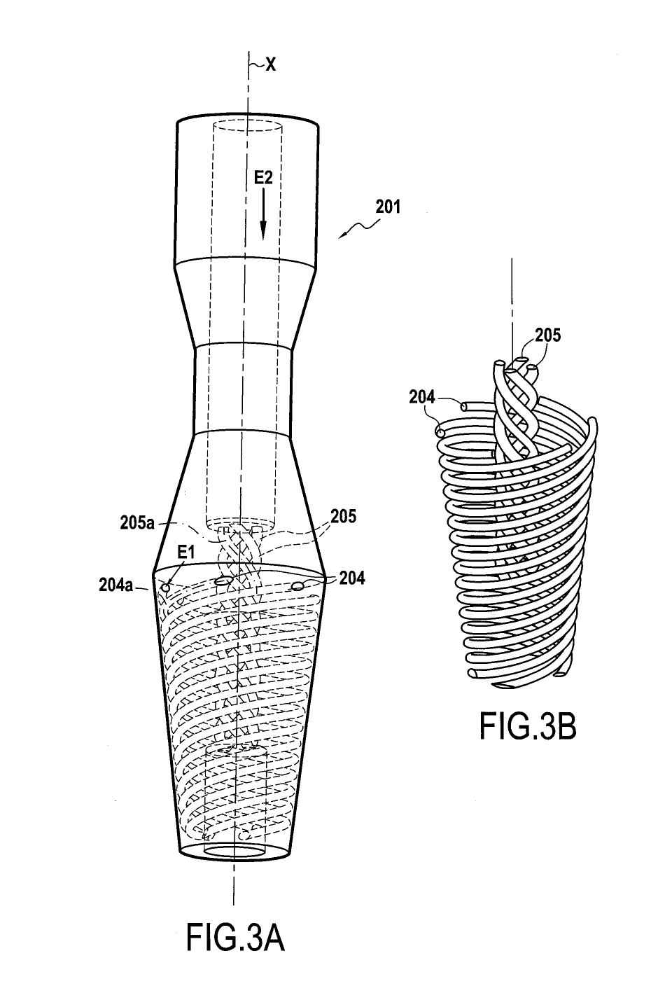

Although the helical channels 204 and 205 in this first embodiment follow circular helices, it is possible to envisage other alternative shapes. Thus, in the embodiment shown in FIGS. 3A and 3B, where each element receives the same reference number as the equivalent element in the first embodiment, the helical channels 204 and 205 follow center lines in the form of conical helices 205a converging on the central axis X in the downstream direction. Thus, during operation of this injector element 201, the flows that are obtained of the propellants E1 and E2 are not only rotating, but also converging. This convergence thus encourages mixing of the two propellants E1 and E2 downstream from the injector element 201. It is possible to envisage other helical shapes for other embodiments. It should thus be understood that in the present context, the term “helix” is used broadly, possibly even covering a line presenting a variable angle relative to the central axis X and thus presenting a variable pitch between spires.

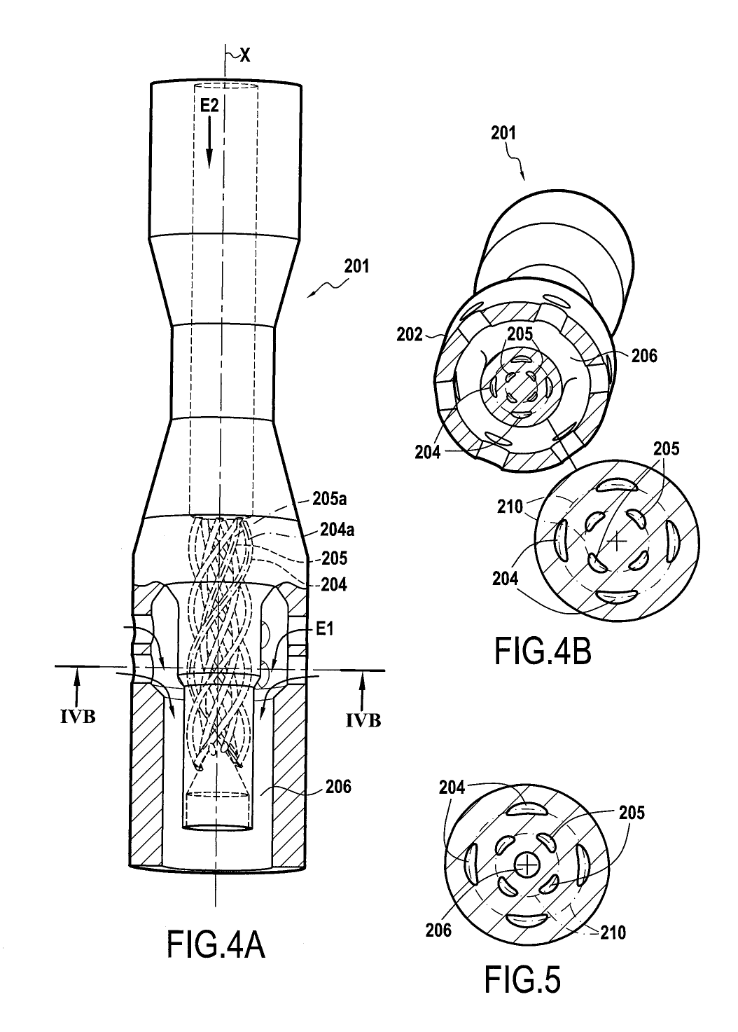

In yet another embodiment, shown in FIGS. 4A and 4B, the concentric first and second helical channels 204 and 205 are all connected to the inlet of the second propellant E2. It is thus possible to inject the second propellant E2 via a plurality of concentric rings 210 of helical channels 204, 205, thereby obtaining a better match to a desired flow rate for the second propellant E2. A third channel 206 of annular section and connected to the inlet for the first propellant E1 serves to inject the first propellant E1. This third channel 206 is situated outside the helices 204a, 205a of the first and second helical channels 204, 205. The remaining elements of the injector element 201 shown in FIGS. 4A and 4B are given the same reference numbers as the corresponding elements in the preceding figures.

Nevertheless, as an alternative, the third channel 206 may be situated inside the concentric rings 210 of the first and second helical channels 204 and 205, as in the embodiment shown in FIG. 5. In this embodiment, the third channel 206 is a straight tubular channel. As in the above-described embodiment, the concentric first and second helical channels 204 and 205 are all connected to the inlet for the second propellant E2, while the third channel 206 is connected to the inlet for the first propellant E1. The remaining elements of the injector element 201 shown in FIGS. 5A and 5B are given the same reference numbers as the corresponding elements in the preceding figures.

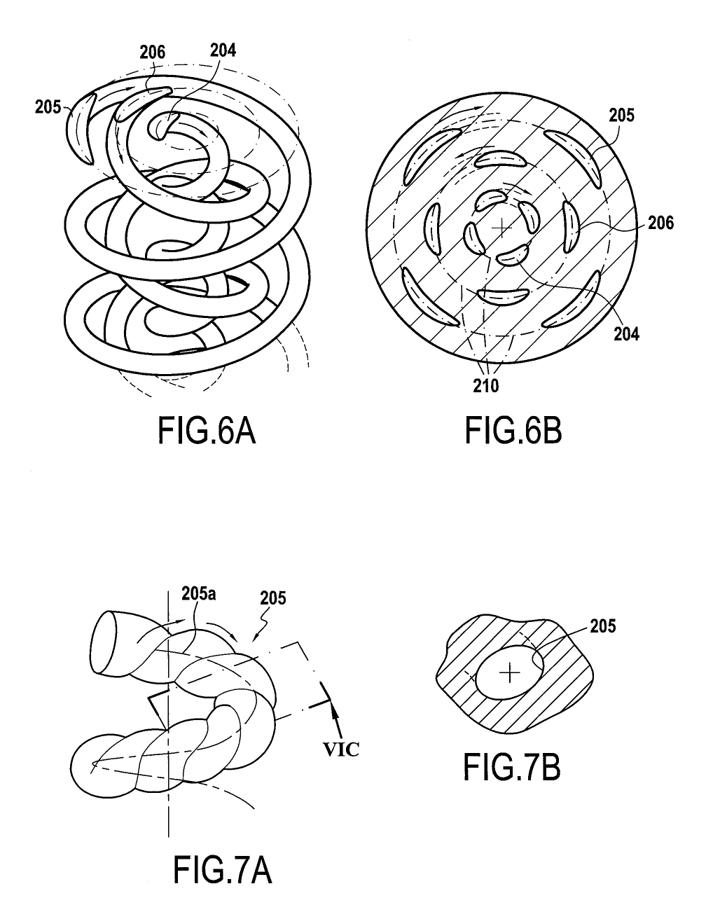

At least one third channel 206 may also be helical, as in the embodiment shown in FIGS. 6A and 6B. In this embodiment, the injector element 201 has a plurality of third helical channels 206 arranged between the first helical channels 204 and the second helical channels 205. As can be seen in FIG. 6A, which is a diagram of one of the channels 204, one of the channels 205, and one of the channels 206, in order to optimize mixing of the propellants E1 and E2 downstream, the third helical channels 206 turn in the opposite direction to the first and second helical channels 204 and 205 about the central axis X. As in the above-described embodiment, the concentric first and second helical channels 204 and 205 are all connected to the inlet for the second propellant E2, while the third channel 206 is connected to the inlet for the first propellant E1.

In each of the above-described embodiments, the helical channels are formed in a single-piece part, thereby making it possible in particular for them to be given a particular section. For example, as shown in FIGS. 7A and 7B, each helical channel 205 may present a non-circular section transversely relative to the helix 205a, this non-circular section being twisted around the helix 205a in order to cause flow lines to turn around the helix 205a. In operation, this provides even more effective mixing of the propellants downstream from the injector element.

Several methods may be used for fabricating single-piece parts of shapes that are this complex. In particular, so-called additive fabrication methods may be used for fabricating such a part. In this context, the term “additive fabrication” is used to mean fabrication methods in which a material is assembled, typically layer by layer, so as to build up a part from data defining a three-dimensional (3D) model. Among additive fabrication methods that are suitable for use in fabricating such a single-piece part, there are in particular selective laser melting and selective laser sintering, both of which methods make it possible to use additive fabrication to make parts out of metallic or ceramic material. Nevertheless, other fabrication methods may be envisaged, such as casting (in particular lost model casting), machining (in particular electric discharge machining), etc. Alternatively, the injector elements may also be produced by assembling a plurality of parts.

Even though the present detailed description refers to a rocket engine having a turbopump actuated by the combustion gases from a gas generator, injectors of the same type could naturally be used in other types of fluid propellant rocket engine, such as for example rocket engines of the so-called “expander” cycle type or rocket engines having pressurized propellants.

Although the present invention is described with reference to a specific embodiment, it is clear that various modifications and changes can be made to these embodiments without going beyond the general scope of the invention as defined by the claims. In addition, individual characteristics of the various embodiments described may be combined in additional embodiments. Consequently, the description and the drawings should be considered in a sense that is illustrative rather than restrictive.

1. An injector element for injecting at least two propellants into a combustion chamber, the injection element comprising at least one first helical channel and at least one second helical channel, each of said helical channels having a center line following a respective helix centered on a central axis of the injector element the injector element being characterized in that wherein the helix of the at least one second helical channel is situated inside the helix of the at least one first helical channel.

2. The injector element according to claim 1, wherein the helix of at least one of said first and second helical channels is a circular helix.

3. The injector element according to claim 1, wherein the helix of at least one of said first and second helical channels is a conical helix.

4. The injector element according to claim 1, wherein at least one of said first and second helical channels presents a non-circular section that is twisted around the corresponding helix.

5. The injector element according to claim 1, wherein the helices of the first and second helical channels turn in opposite directions.

6. The injector element according to claim 1, wherein the first helical channel is connected to an inlet for a first propellant and the second helical channel is connected to an inlet for a second propellant, which inlet is separate from the inlet for the first propellant.

7. The injector element according to claim 1, further including at least one third channel.

8. The injector element according to claim 7, wherein said third channel is also helical, following a helix also centered on the central axis of the injector element.

9. The injector element according to claim 7, wherein said third channel is annular.

10. The injector element according to any claim 1, wherein at least said first and second channels are formed inside a single-piece part.

11. The injector element according to claim 10, wherein said single-piece part is produced by additive fabrication.
